(19) United States
(12) Patent Application Publication
(10) Pub. No.: US 2007/0278398 A1
(43) Pub. Date: Dec. 6, 2007

(54) Ion mobility spectrometry waveform

(76) Inventor: Gangqiang Li, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/442,232

(22) Filed: May 30, 2006

(51) Int. Cl. H01J 49/40

(52) U.S. Cl. 250/287; 250/282

(57) ABSTRACT

A high-field asymmetric waveform ion mobility spectrometer (FAIMS) with enhanced ion focusing is provided. The apparatus comprises an outer electrode with a central region and inner surface and an inner electrode disposed in the central region of the outer electrode. The inner and outer electrodes are positioned to form a non-uniform gap between the inner electrode and outer electrode inner surface. A method of using the apparatus to analyze ionized samples is also provided.

### TECHNICAL FIELD

The invention relates generally to ion analysis and more particularly to ion analysis in ion mobility spectrometry.

### BACKGROUND

High-Field Asymetric Waveform Ion Mobility Spectrometry (FAIMS) is a technology useful both for the separation of gas-phase ions at atmospheric pressure and room temperature as well as separation of gas phase ions over a wide range of mass to charge ratios and molecular mobility.

In general, FAIMS is characterized by several features. These features include:

(1). Strong radio frequency electric fields are used in FAIMS. Typically, FAIMS operates with fields greater than 5,000 volts/cm.

(2). In FAIMS a periodic asymmetric electric waveform is applied to conductive surfaces (e.g., electrodes) about 1-4 mm apart. The electric waveform is asymmetric which means that there is a significant difference between the peak +Ve and the peak −Ve voltage during the applied waveform. Either the +Ve or the −Ve may be the higher voltage.

(3). In FAIMS ions move through a gas in the electric field generated by the periodic asymmetric electric waveform. The gas is sufficiently dense that the ions rapidly reach a terminal velocity that is roughly proportional to the strength of the electric field. The velocity is compound dependent, permitting the separation of species of ions from each other. The ions drift toward one of the electrodes as they travel in the electric field. Typically, this drift may be stopped by applying a small DC voltage known as a compensation voltage (CV) which allows an ion species of a selected mobility to pass through the field region to a detector.

Conventionally, a pair of planar plates are used as the conductive surfaces or electrodes (e.g. plate electrodes). However, the use of concentrically aligned, coincident axis cylindrical electrodes has been shown. For example, in U.S. Pat. No. 5,420,424 (the '424 Patent), Carnahan et al. disclose the use of two concentrically aligned cylinder electrodes with coincident axes as the electrodes in a FAIMS instrument. Guevremont et al. (Review of Scientific Instrument, Vol. 70, 1370, 1999) discloses that ions appear to be trapped or focused in the annular space between the cylindrical electrodes, and further discloses a FAIMS apparatus with aligned cylindrical electrodes with coincident axes and an annular ion exit orifice. Typically, in such instruments the ions propagate in a longitudinal direction parallel to the axes of the cylindrical electrodes. However, Guevremont and Purvis, in patent application WO 03/067236, disclose the use of cylindrical electrodes in a FAIMS apparatus in which the ion mobility movement occurs circumferentially between the inner and outer electrodes. For the known examples of cylindrical electrode FAIMS apparatuses, the inner and outer electrodes are concentrically aligned such that the gap between the inner and outer electrode is the same (uniform) at all points along the length of the cylinder.

There is a need for improved FAIMS devices, particularly devices with improved ion focusing power and improved sensitivity.

### SUMMARY

An apparatus for separating ions, comprising a high field asymmetric waveform ion mobility spectrometer, is provided. The apparatus includes an analyzer region comprising an inner electrode having an external surface and an inner electrode center axis and a hollow outer electrode having an inner surface, a central region and an outer electrode center axis. The inner electrode is disposed in the central region of the hollow outer electrode. The inner electrode center axis and outer electrode center axis are parallel and non-coincident, thus forming a non-uniform gap between the inner electrode external surface and the hollow outer electrode inner surface. The apparatus also includes a contact for applying an asymmetric waveform to one of the inner electrode and outer electrodes and a contact for applying a compensation voltage to the other of the inner and outer electrodes. The non-uniform gap has a wide gap region and a narrow gap region and two apertures are positioned in the hollow cylindrical electrode. A first aperture of the two apertures is positioned adjacent the wide gap region and a second aperture of the two apertures is positioned adjacent the narrow gap region. The apparatus may further comprise an ion source and a detector.

A method for separating ions is also provided. The method comprises the steps of providing a plurality of ionic species, providing the FAIMS apparatus disclosed herein providing a high field asymmetric waveform to the inner electrode to generate a high field in the non-uniform gap, setting the high field asymmetric waveform in order to effect a displacement between a first and a second ion species of the plurality of ion species in the time of one cycle of the applied asymmetric waveform, and applying a compensation voltage to the hollow outer electrode.

### DETAILED DESCRIPTION OF THE DRAWINGS

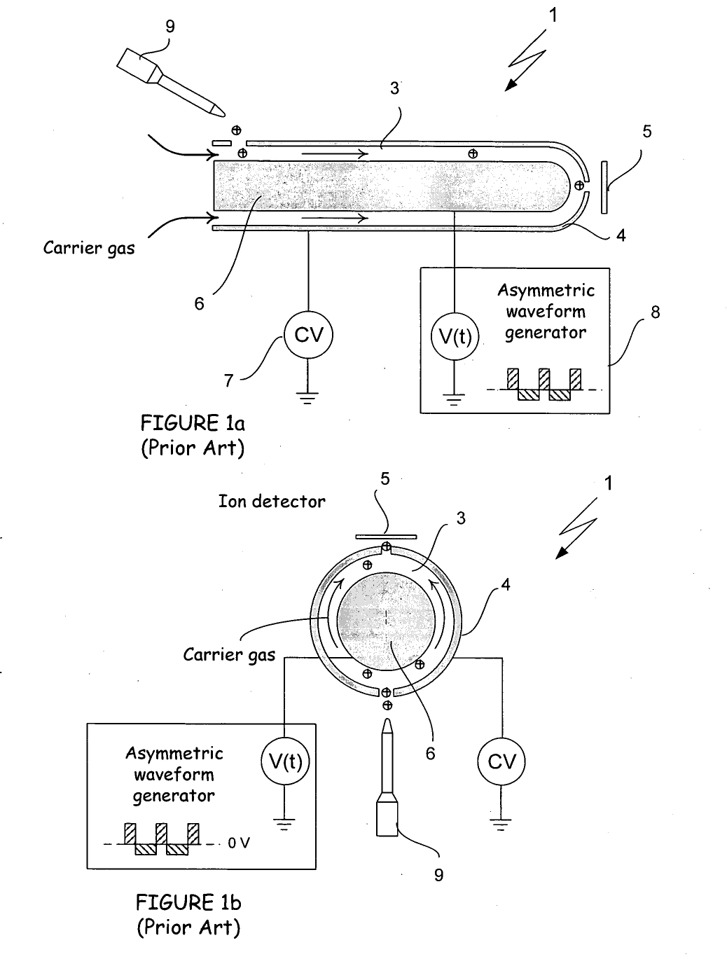

FIG. 1(a) is longitudinal cross-sectional schematic diagram of a prior art FAIMS instrument having cylindrical electrodes. FIG. 1(b) is a cross-sectional diagram of a prior art FAIMS instrument having cylindrical electrodes.

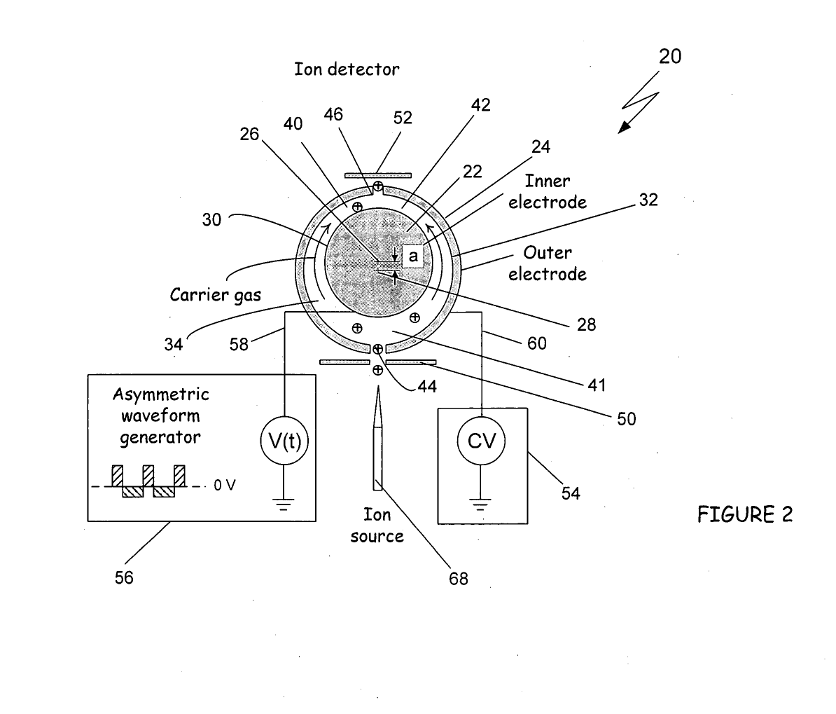

FIG. 2 is a cross-sectional schematic diagram of an high-field asymmetric waveform ion mobility spectrometer with enhanced ion focusing.

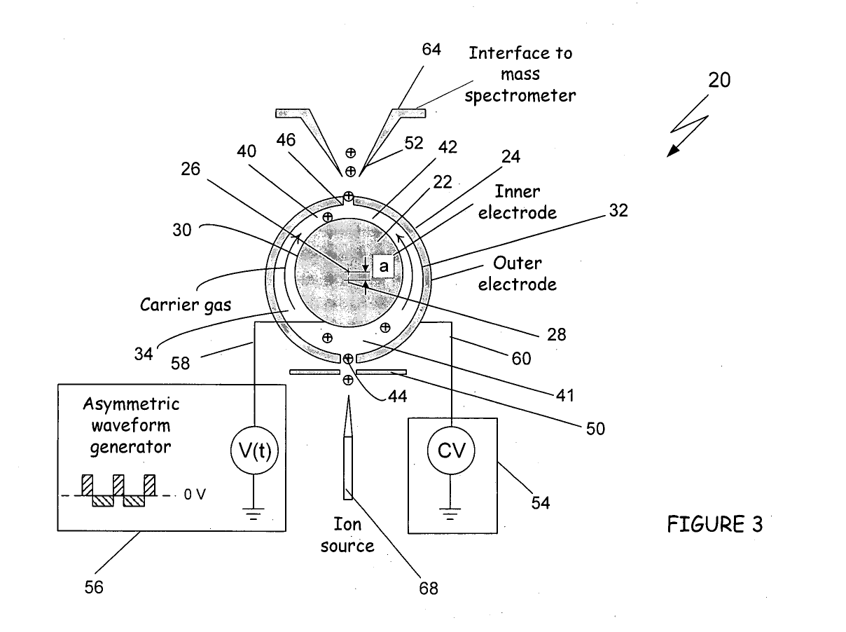

FIG. 3 is a cross-sectional schematic diagram of an ion mobility spectrometer with enhanced ion focusing interfaced to a mass spectrometer.

### DETAILED DESCRIPTION

Embodiments described herein provide a FAIMS apparatus with enhanced ion focusing and a method of using the apparatus for analysis of ionized samples. In one embodiment the apparatus has two cylindrical electrodes which include a hollow outer electrode and an inner electrode positioned in the central region of the outer electrode. The axes of cylindrical inner and outer electrodes are parallel but not coincident. Such positioning of the electrodes forms a non-uniform gap between the electrodes. Namely, the gap between the cylinders is narrower on one side of the apparatus and wider on the other side. An ion entrance aperture is placed near the wide gap region. The placement of the ion entrance aperture proximate the wide gap region may facilitate collection of ions from an ion source. An ion exit aperture is positioned proximate the narrow gap region. When an asymmetric waveform is applied to one electrode an asymmetric radio frequency field (e.g., a “dispersion field” or “field”) is formed in the gap. To transmit a selected ion species through the gap from the ion entrance aperture to the ion exit aperture in the presence of the dispersion field, a compensation voltage is applied to the other electrode which creates a compensation field in the gap. As ions propagate from the entrance aperture into the narrow gap region to the exit aperture, the ions experience an incremental increase in the dispersion and the compensation fields as they travel. The incremental increase in the dispersion and compensation fields serves to focus the ions into a narrowed ion beam as they are transmitted to the exit aperture.

The enhanced focusing of the apparatus enhances the sensitivity of the FAIMS apparatus. The apparatus and method have many applications and are particularly useful in applications in which a FAIMS apparatus is interfaced to a mass spectrometer or other second stage analyzer.

Cross-sectional schematic diagrams of prior art FAIMS spectrometers with cylindrical electrodes are shown in FIGS. 1a and 1b. The apparatus 1 has an outer hollow cylindrical electrode 4 and an inner cylindrical electrode 6. The diameter of the inner electrode 6 is less than the diameter of the hollow outer electrode 4, thus creating a gap or ion channel 3 between the inner and outer electrodes 4, 6. The inner cylindrical electrode 6 and outer hollow cylindrical electrode 4 are positioned such that the longitudinal center axes of the electrodes 4, 6 are coincident. An asymmetric waveform generator 8, generates an periodic asymmetric waveform that is applied to the inner cylindrical electrode 6 and a compensation voltage source 7 provides a compensation voltage to the outer electrode 4. Ions from an ion source 9 are supplied to the gap 3 via a carrier gas which is admitted to the ion channel 3. Ions with a selected ion mobility characteristic pass through the ion channel 3 to a detector 5. The direction of ion travel may be in a longitudinal direction along the length of the electrodes 4, 6 as shown in FIG. 1a or alternatively in a transverse direction around the circumference or a portion of the circumference of the inner cylindrical electrode 6 as shown in FIG. 1b.

Embodiments described herein provide an apparatus and method for enhanced focusing of ions in FAIMS. Enhanced focusing may improve sensitivity generally and is also useful if a second stage of analysis such as a second stage FAIMS apparatus, or a mass spectrometer, for example, is used in combination with the apparatus. When a second stage of analysis is employed, the apparatus not only provides for enhancing sensitivity, but also for facilitating efficient transfer of ions to the second analyzer. The enhanced ion focusing may be achieved at a manufacturing cost comparable to a conventional FAIMS instrument.

FIG. 2 shows an exemplary embodiment. In the embodiment shown in FIG. 2, the apparatus 20 comprises a cylindrical inner electrode 22 and a cylindrical outer electrode 24. The outer cylindrical electrode 24 is hollow. The inner cylindrical electrode 22 may be a rod or hollow cylinder which has a diameter less than the diameter of the cylindrical outer electrode 24. The inner electrode 22 has an inner electrode center axis 26 and an external surface 30. The cylindrical outer electrode 24 has a center axis 28, an inner surface 32 and a central region 34. The cylindrical inner electrode 22 is disposed in the central region 34 of the hollow cylindrical outer electrode 24. The center axis 26 of the inner electrode 22 and the center axis 28 of the outer electrode 24 are parallel and non-coincident.

In the embodiment shown in FIG. 2, the center axis 26 of the inner electrode 22 and the center axis 28 of the outer cylindrical electrodes 24 are offset by a distance “a”. The offset or shift of “a” may be about 10% to about 90% of the gap width of a conventional configuration with coincident center axes. For a conventional configuration the gap width is determined by the equation: gap width=(Dₒᵤₜₑᵣ−dᵢₙₙₑᵣ)/2 where Dₒᵤₜₑᵣ is the inner diameter of the outer electrode and dᵢₙₙₑᵣ is the outer diameter of the inner electrode.

A non-uniform or asymmetrical gap 40 is formed between the inner electrode external surface 30 and the outer electrodes inner surface 32. As shown in FIG. 2, the gap 40 has wide gap region 41 and a narrow gap region 42 positioned on opposite sides of the apparatus 20. An ion entrance aperture 44 is positioned adjacent the wide gap region 41. The entrance aperture 44 permits ions and carrier gas to enter into the gap 40 (e.g., enter the ion channel). An exit aperture 46 is positioned adjacent the narrow gap region 42. The exit aperture 46 permits ions to exit the ion channel 40, e.g., for delivery or transfer to a detector 52 or another stage of analysis. The entrance aperture 44 and exit aperture 46 are placed in the same plane and are perpendicular to the inner and outer electrode axes 26 and 28.

The apparatus 20 further includes an ion source 68 which provides ions that are transferred into the gap 40 (i.e., the ion channel) via the entrance aperture 44. Transfer of ions generated in the ion source 68 into the ion channel 40 is facilitated by applying a potential difference between the ion source 68 and one of the cylindrical electrodes 22. 24. Optionally, a lens system 50 may be used to direct ions from the ion source 68 into the entrance aperture 44 and the gap 40.

The carrier gas flows in the gap 40 in a direction from the entrance aperture 44 to exit aperture 46. The carrier gas is the gas in which the ion mobility is to be measured. The carrier gas may be admitted via a conventional valving system (not shown) or by any other system that permits reproducible regulation of the flow of the carrier gas. The carrier gas may be introduced at room temperature. Alternatively, in some embodiments the carrier gas may be heated prior to admission to the gap 40.

Carrier gases suitable for use in a conventional FAIMS system are likewise suitable for use in the enhanced focusing FAIMS system. For example, carbon dioxide, nitrogen, oxygen or mixtures of gases may be used. Defined identity of the gas composition as well as an apparatus for regulating and measuring flow rate of the carrier gas are desirable as such factors and parameters facilitate reproducibility of analyses.

The apparatus 20 further comprises a detection system 52 positioned adjacent exit aperture 46. The detection system 52 includes provision for detecting ions passing through gap 40 and exit aperture 46. The detection system 52 may directly detect ions and/or transfer ions for an additional stage of analysis. Suitable detectors for detecting ions include but are not limited to Faraday cups, Faraday cups with amplification systems, photomultipliers, diode arrays, and scintillation detectors, for example. Optionally, the detection system may collect ions for an additional stage of analysis such as a second stage of FAIMS or mass spectrometry. The subsequent analyses may provide further structural characterization of selected ion species and/or quantitative data, for example. FIG. 3 shows an embodiment with an exemplary interface 64 to a mass spectrometer (not shown).

Referring again to FIG. 2, the inner electrode 22 has inner electrode contact 58 which permits application of an asymmetric waveform to the inner electrode 22. The asymmetric waveform is produced by an asymmetric waveform generator 56. Application of the asymmetric waveform creates an electric field in the gap 40.

The apparatus 20 further comprises an outer electrode contact 60. The outer electrode contact 60 provides for the application of a compensation voltage from a compensation voltage source 54 to the outer electrode 24. The compensation voltage source 54 may be a power supply, for example. The compensation voltage should be controllable in magnitude and duration. Adjustment of the magnitude of the compensation voltage permits selection of the species of ion to be passed through the gap 40 from the entrance aperture 44 to the exit aperture 46. The compensation voltage can be set to pass a selected ion species through the gap 40 for a determined period of time. Alternatively, the compensation voltage may be adjusted in a predetermined systemic manner (scanned) to provide for sequential detection of a plurality of ion species (i.e., ion species from various components of the sample).

FIGS. 2 and 3 show the asymmetric waveform generator 56 to be connected to the inner electrode 22 and the compensation voltage source 54 to be connected to the outer electrode 24. This is exemplary. Alternatively, the asymmetric waveform generator 56 could be connected to the cylindrical outer electrode 24 and the compensation voltage source 54 could be connected to the cylindrical inner electrode 22.

Although a cylindrical electrode embodiment of the apparatus has been described in detail herein, it is not required that the geometry of the electrodes be cylindrical or that both electrodes have the same shape. For example, any geometry of inner and outer electrodes may be used so long as the gap between the electrodes is wider at the ion entrance than in the region near the ion exit. Furthermore, the electrodes do not have to have the same shape. For example, a combination of cylindrical inner electrode and elliptical outer electrode or visa versa could be used so long as the gap between the electrodes was wider proximate the ion entrance than proximate the ion exit.

As to construction, the electrodes may be constructed from a conductive material or non-conductive material with conductive plating or some combination thereof. The electrodes can be made as an integrated structure so long as the conductive region that forms one electrode is electrically isolated from the conductive region that forms the other electrode. Micro-machining may be employed to facilitate construction of the electrically isolated electrodes.

To analyze a sample, a plurality of ion species from the ion source are introduced into the gap 40 via the entrance aperture 44 (e.g., into the region between the inner electrode 22 and outer electrode 24). An ion species is an ion with recognizable distinctive or characteristic features of composition and/or charge.

Ions may be derived from a variety of ion sources 68, including but not limited to ionization of a sample in a device such as an electrospray ionization source, an atmospheric pressure chemical ionization source (APCI), an atmospheric pressure ionization source (API), an atmospheric pressure MALDI (matrix assisted laser desorption ionization) source, a discharge source, and a radioactive ionization source. The sample may be introduced into the ion source 68 by direct probe or infusion pump, for example. Alternatively, the sample may be introduced into the ion source 68 as effluent from a gas chromatograph, a liquid chromatograph or capillary electrophoresis or as ions transported in a gas stream from an environmental or process monitoring sample.

Typically the ions introduced into the FAIMS apparatus 20 are a mixture of ion species. A potential differential between the ion source 68 and the inner electrode 22 facilitates transfer of ions. The plurality of ion species are introduced into a stream of carrier gas which is admitted to the ion channel or gap 40. Typically, nitrogen, oxygen or carbon dioxide is used as the carrier gas. However, other gases or gas mixtures may be used. Typically, a gas with a low propensity for chemical reaction with the ions of interest is preferred. As the ions travel in the stream of carrier gas in the gap 40 from the entrance aperture 44 to the exit aperture 46, the asymmetrical waveform generator 56 applies an asymmetric high voltage waveform to the cylindrical inner electrode 22 via contact 58, generating a time dependant high field (e.g., typically greater than 5000 V/cm). The high field causes ions traveling in the gap 40 to drift towards the opposite electrode (e.g., outer electrode 24). Absent other forces, ions will collide with the outer electrode 24 and fail to pass through the gap 40 to exit aperture 46.

The degree of drift depends on the mobility character of a particular ion species in the carrier gas. Ion size, chemical composition and charge are exemplary of the factors that determine the ion mobility characteristic of a specific species of ions and accordingly degree of drift. If a DC voltage (e.g., compensation voltage or CV) is applied to the electrode opposite the electrode to which the asymmetric waveform is applied (e.g., electrode 24 in the example of FIG. 2), a compensation field is generated. In the presence of the additional compensation field, ions are forced to move in a direction opposite the initial drift. With an appropriately chosen compensation voltage (namely, selection of a CV with a suitable polarity and magnitude), the movement of a single species of ions with a particular selected mobility character is balanced between the inner electrode 22 and outer electrode 24 and the selected ion species can migrate through the gap 40 to the exit aperture 46 and detector 52. Other species of ions of the plurality of ion species in the sample having different mobility character hit one of the electrodes 22, 24 and become discharged.

The selected ion species travels to the exit aperture 46 and is transferred to the detector system 52. The detector system may directly collect data or transfer the ions to a second stage of analysis such as another stage of ion mobility spectrometry or mass spectrometry. The detector system 52 is positioned to receive the focused beam of ions that passes though the exit aperture 46.

Typically, when a beam of a mixture of ion species is introduced into the FAIMS spectrometer from the ion source 68, either the compensation voltage is set to transmit a selected ion species of interest and monitor that ion species for a period of time or the compensation voltage is varied with time (scanned) so that ions of different compounds sequentially pass through the gap 40 between the inner and outer cylindrical electrodes 22, 24 to the detector system 52. In principle, for a given compensation voltage only a single ion species with a specific particular ion mobility characteristic can pass through the gap 40 and be detected at a given time. Other species of ions in the sample fail to pass through the gap and become discharged. As indicated, the compensation voltage may be adjusted in a predetermined systematic manner (e.g., scanned) to provide for sequential detection of a plurality of ion species. Detecting ions sequentially yields an ion mobility spectrum as a function of compensation voltage.

The foregoing discussion discloses and describes many exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention which is set forth in the following claims.

1. An apparatus for separating ions, comprising:
(a) an analyzer region comprising an inner electrode and an outer electrode, the inner electrode having an inner electrode external surface, the outer electrode having an outer electrode internal surface and a central region, wherein the inner electrode is disposed in the central region of the outer electrode forming a non-uniform gap between the inner electrode external surface and the outer electrode inner surface;
(b) a contact for applying an asymmetric waveform to one of the inner electrode and outer electrodes; and
(c) a contact for applying a compensation voltage to one of the inner electrode and the outer electrodes.

2. The apparatus of claim 1, wherein the non-uniform gap has a wide gap region and a narrow gap region.

3. The apparatus of claim 2, further comprising two apertures in the outer electrode wherein a first aperture is positioned adjacent the wide gap region and a second aperture is positioned adjacent the narrow gap region.

4. The apparatus of claim 3, wherein the first aperture is an entrance orifice for admitting ions into the non-uniform gap.

5. The apparatus of claim 4, further comprising an ion source adjacent the entrance orifice, wherein the ion source provides ions and wherein the ions are admitted into the wide gap region via the entrance orifice.

6. The apparatus of claim 5, the ion source further comprising an ion lens between an ion forming portion of the ion source and the entrance orifice.

7. The apparatus of claim 3, wherein the second aperture is an exit orifice for transmitting ions from the non-uniform gap.

8. The apparatus of claim 7, further comprising an ion detector, wherein the ion detector is adjacent the exit orifice.

9. The apparatus of claim 7, further comprising a detection system adjacent the exit orifice, wherein the detection system collects ions for an additional stage of analysis.

10. The apparatus of claim 1, further comprising a scanning system in communication with the contact for applying a compensation voltage, wherein the scanning system changes the compensation voltage in a predetermined sequence.

11. A high field asymmetric waveform ion mobility spectrometer comprising:
(a) an ion source;
(b) an analyzer region adjacent the ion source; the analyzer region comprising: (i) an inner electrode having an external surface and an inner electrode center axis and a hollow outer electrode having an inner surface, a central region and an outer electrode center axis, wherein the inner electrode is disposed in the central region of the hollow outer electrode and the center axis of inner electrode and the center axis the outer electrode are parallel and non-coincident, thereby forming a non-uniform gap between the inner electrode external surface and the hollow outer electrode inner surface, a contact for applying an asymmetric waveform to the inner electrode, and a contact for applying a compensation voltage to the hollow outer electrode; and
(c) a detector adjacent the analyzer region.

12. The high field asymmetric waveform ion mobility spectrometer of claim 11, wherein the inner electrode and the hollow outer electrode are cylindrical electrodes.

13. The high field asymmetric waveform ion mobility spectrometer of claim 11, wherein the non-uniform gap has a wide gap portion and a narrow gap portion.

14. The high field asymmetric waveform ion mobility spectrometer of claim 11, further comprising a first and a second aperture in the hollow cylindrical outer electrode wherein the first aperture is adjacent the wide gap portion and the second aperture is adjacent the narrow gap portion.

15. The high field asymmetric waveform ion mobility spectrometer of claim 11, wherein the ion source is in communication with the first aperture and the detector is in communication with the second aperture.

16. The high field asymmetric waveform ion mobility spectrometer of claim 11, further comprising a scanning system in communication with the contact for applying the compensation voltage, wherein the scanning system changes the compensation voltage in a predetermined sequence.

17. A method for separating ions comprising the steps of:
(a) providing a plurality of ionic species;
(b) providing an analyzer including an analyzer region comprising a inner electrode having an external surface and an inner electrode center axis and a hollow outer electrode having an inner surface, a central region and an outer electrode center axis and wherein the inner electrode is disposed in the central region of the hollow outer electrode and the center axis of inner electrode and the center axis the outer electrode center are parallel and non-coincident thereby forming a non-uniform gap between the inner electrode external surface and the hollow outer electrode inner surface;
c) providing an asymmetric waveform to one of the inner electrode and the outer electrode to generate a high field in the non-uniform gap;
d) setting the high field asymmetric waveform in order to effect a difference in net displacement between a first and a second ion species of the plurality of ion species in the time of one cycle of the applied asymmetric waveform;
e) applying a compensation voltage to one of the inner electrode and the outer electrode.

18. The method of claim 17, wherein the compensation voltage is set to a determined value to support transmission of a first ion species through a portion of the non-uniform gap.

19. The method of claim 17 further comprising detecting the first ion species after transmission through a portion of the non-uniform gap.

20. The method of claim 17, wherein the compensation voltage is scanned in a predetermined sequence permitting transmission of at least a first and a second ion species of the plurality of ionic species through a portion of the non-uniform ion gap sequentially.

21. The method of claim 17 further comprising providing an entrance orifice and an exit orifice in the outer electrode and a carrier gas in the non uniform gap, wherein the carrier gas flows in a direction from the entrance orifice to the exit orifice.
